(19) United States
(12) Patent Application Publication
(10) Pub. No.: US 2015/0358165 A1
(43) Pub. Date: Dec. 10, 2015

(54) METHOD AND ARRANGEMENT FOR DISTRIBUTED REALISATION OF TOKEN SET MANAGEMENT AND RECOMMENDATION SYSTEM WITH CLUSTERING

(71) Applicant: Teknologian tutkimuskeskus VTT Oy, Espoo (FI)

(72) Inventors: Ville OLLIKAINEN, VTT (FI); Raimo LAUNONEN, VTT (FI); Atte KORTEKANGAS, VTT (FI)

(21) Appl. No.: 14/732,807

(22) Filed: Jun. 8, 2015

Related U.S. Application Data
(60) Provisional application No. 62/009,274, filed on Jun. 8, 2014.

(51) Int. Cl. H04L 9/32; G06F 17/30

(52) U.S. Cl. CPC H04L 9/3234; G06F 17/3097

(57) ABSTRACT

Method (400) for managing a plurality of digital token sets (202, 202b, 202c), wherein each digital token set comprises a plurality of tokens (203) and is associated with a digital item available for access via an e-service, wherein the digital tokens are identifiable elements of substantially no semantic value and interaction between a user-related token set and item-related token set involves adapting both token sets based on the token set of the other party of the interaction, comprises obtaining a first plurality of token sets associated with a corresponding plurality of digital items (300), distributing (304) said first plurality of token sets among a second plurality of at least computationally separate but communications-wise connected, functionally parallel partial repositories (202, 204, 206), wherein said second plurality is smaller than the first plurality, the partial repositories establishing a greater joint, distributed repository, wherein said distributing comprises utilization of a predefined evaluation logic (306, 308, 310, 312, 314) to allocate mutually similar item related token sets to the same partial repository in said second plurality. A corresponding arrangement is presented.

### FIELD OF THE INVENTION

Generally the present invention relates to electronic computing devices and corresponding systems of multiple interconnected devices. Particularly, however not exclusively, the present invention pertains to the management of item related token sets comprising a number of identifiable tokens having no semantic value, and execution of related distribution, matching and recommendation tasks.

### BACKGROUND

Recommendations have become essential in creating additional value for service providers including e.g. mobile service providers. Contexts play a focal role in understanding what the users of a mobile service want or need. Thus, understanding a user's context and acting based upon it is of the utmost importance for a service to be successful. According to a more general approach, it can be said that there are numerous computational problems, the purpose of which is to predict the behavior of an entity, and for these problems e.g. genetic algorithms are applicable. Also, genetic algorithms can be used for understanding the context of a user and making recommendations thereafter.

The recommendation problem can be defined as estimation of the response of a user for new items, based on e.g. historical information stored in the system, and suggesting to this user novel and original items for which the predicted response is high (e.g. Desrosiers, C., Karypis, G.: A comprehensive survey of neighborhood-based recommendation methods. pp. 107-144. Boston, Mass.: Springer US, 2011). Various recommending algorithms have been proposed in the literature, most commonly classified into two basic categories: content-based and collaborative recommendations. Content-based recommendation methods are based on representing the items with a set of attributes, and using these attributes to find most relevant content for a user. Collaborative recommendation methods, on the other hand, learn from user behaviour.

In academic literature (e.g. Lops, P., de Gemmis, M., & Semeraro. G.: Content-based recommender systems: State of the art and trends. pp. 73-105. Boston, Mass.: Springer US, 2011) the following challenges are often mentioned regarding content-based recommendations:
need for domain knowledge
over-specialization (so called serendipity problem)
user profile creation
item representation.

Social networking has been taken into account in the literature: For instance a publication (Golbeck, J.: Generating predictive movie recommendations from trust in social networks. pp. 93-104. Springer-Verlag Berlin, Germany) shows how trust and social networks can be exploited to refine the user experience. Another publication (Liu, F., Lee, H. J.: Use of social network information to enhance collaborative filtering performance. Expert Systems with Applications, 37(7), pp 4772-4778, 2012) suggests using social networking by emphasizing preferences of those users which, at the same time, are nearest neighbours and belong to the social network of a user.

In EPI 2,249,261 Arpit Mathur presents a recommendation system which is based on social networking. In the presented approach preference information of a user is a necessity. Content item, which is accessed by a member of the same group as the said user, is recommended to the user based on this group relation. This is also known as collaborative filtering.

Content-based filtering is utilized in WO 2,009,146,489 by Dalgleish Andrew Robert. An item is recommended to a user by using rules, which determine the links between item features and the user's personal features.

Fishman Alex and Chai Chai Crx K. introduce a community-based recommendation engine in US 2,010,064,325. User receives a content recommendation from her contact. The recommendation engine determines the action to be performed according to the recommendation and on one or more rules, such as trust level of the contact, etc.

Based on similar relevance values as above, such as trust or similarity between the search user and the entity providing the search results, a recommendation system is presented in US 2,011,010,366 by Varshavsky Roy et al. The entities may be virtually anything. The relationships between the user and the entity may be created through many different contact mechanisms and may be unidirectional, asymmetric bidirectional, or symmetric bidirectional relationships. The relationships may be different based on topic or other factors.

In EP 2,207,348 Barbieri Mauro and Pronk Serverius examine the challenges related to insufficient metadata. They present an apparatus for controlling of a recommender system which provides recommendations for a new, unknown domain, or area of interest, by using one or more user profiles from other, known domains. This is achieved by forming or using translations or relations between the known domains and the new domain, and by exploiting these translations or relations to extend the profiles in the known domains into the new domain.

Becker Ralf et al. present an invention (EP 2,242,259) optimized for cross-domain recommendations by enabling the issuing of a recommendation for related predetermined content at a particular appropriate timing. Taken into account in the process are current broadcast content, past and future programs available from a service network and the user's viewing history.

Foster Benjamin et al. describe, in US 2,010,325,011, a method to facilitate generating listing recommendations to a user of a network-based commerce system. This method identifies a search term that corresponds to a category of items, which includes a plurality of listings hosted by a network-based system. Furthermore, a recommendation query is generated that includes the identified search term. A listing is identified from the plurality of listings as a recommended listing. The identification is based on the recommendation query.

Based on user's listings representing items for sale on the marketplace, user profile is formed, in WO 2,010,114,903 by Kassaei Farhang. The user profile is compared with other similar users who have subscribed to various applications, and the impact those applications have had on the metrics of the similar users is calculated in order to determine what impact the applications will have on the user in question. The impact, combined with user preferences, is used to suggest appropriate applications to the user.

Murphy Shawn M. et al. present in US 2,010,325,205 an event recommendation service. Known selection data is compared with media content selected by a user, location data that corresponds to location of the user and event data are used to make recommendations of events the user is likely to attend.

Thus many prior art solutions somewhat regrettably disclose users' personal history or personal preferences in a process of requesting a recommendation. Yet, constructing a recommendation system seems to require various tedious preparatory stages of collecting and processing metadata associated with entities belonging to the potential recommendation space or receiving the recommendations.

It should be noted that trading personal information has become a significant business e.g. in loyalty card programs and social media. In these cases there is business value in aggregating user data while the monetary benefit for each user is relatively low. An approach has been proposed that a user could directly sell his profile data. Without middlemen there is at least in theory an opportunity to get most value in return from providing the data. However, with the conventional approach the user could trade or exchange his profiling data for one entity only once, since the data is expected to remain fairly static.

Further, implementing and adopting typical standalone recommendation systems may generally easily fall into a number of pitfalls that basically relate to the uniqueness and seclusion of each particular solution as whenever new entities such as users, articles for trade or consumption, etc. appear therein, they simply lack the characteristic profile data and data based on interaction history that is, however, in most such solutions necessary for determining relevant matches between them. In other words, it takes a long time or at least a considerable amount of adaptation for a new entity to be integrated in an isolated solution in terms of meaningful, valid recommendations from the standpoint thereof. Since the vast majority of contemporary recommendation engines are based on data gathered from a single service, this cold start problem is almost inevitable. In these cases, since data is gathered from a single service, the scope lacks a holistic view of overall user preferences.

Building up and dynamically managing recommendation engines and e.g. related sensitive/private information such as user profiles or preferences locally in secure manner with appropriate databases, is not in the core focus of most e-service providers like media houses or e-commerce operators either unless, in return, they can clearly provide better-targeted content to the users. Indeed, inaccurate recommendations may cause more annoyance than obtaining no recommendations at all. On the contrary, from a user point of view, happy surprises, often referred as serendipity, are not typically provided by most contemporary content-based recommenders.

In contrast to traditional thinking according to which personalization is based on gathering information of personal preferences and disclosing them to service providers, a safer to use recommendation system relying on adaptive token sets may be constructed. Patent application publication WO14029904 discloses a mechanism for maintaining personal token sets of identifiable tokens for different entities such as users, e-services like Internet-accessible web sites, and e.g. data elements (media items, files, web pages, product descriptions, etc.) accessible through the services. Based on interaction between typically two entities, including, for instance, a user visiting a web page incorporating a data element the user inspects or ‘clicks’, i.e. accesses, the token sets of the associated interaction parties are updated to resemble the token set of the other party more than prior to the interaction. Such update action may comprise copying tokens between the sets. The past interactions of an entity will be thus reflected by its token set in the construction of the set.

FIG. 1 illustrates one basic concept underlying '904, wherein token set 17, 29 associated with each interacting entity 21, 22 is updated 214, 215 as a result of the interaction 18 between the entities and based on the token set of the other entity. The entities 21, 22 may refer to a user and an c-service or c-service resource the user is interacting with, for instance. The update of a token set 17, 29 involves information exchange 28, particularly receiving at least part of the other token set 29, 17. Tokens 24 associated with the first interacting unit 21 may be updated by copying thereto a number of tokens from among the tokens 25 associated with the second interacting unit 22, for instance, whereupon the token sets 17, 29 will increasingly share common tokens after the interaction.

The actual number of tokens copied may be determined as a percentage 27 indicating how large the intended change to the token set is (whereas in contrast, percentage 26 indicates the portion of the original token set 24 to remain unaltered during the interaction 18). The percentage 27 may indicate the number of tokens copied relative to the total amount of tokens in the set. Choosing the tokens to be copied from the other token set may be based on a random selection.

Accordingly, recommendations for potentially interesting entities/items may be searched from the standpoint of a target entity 21, such as an e-service user, by determining the token sets of candidate entities, such as product items or other accessible items, which are most similar with the token set of the target entity. These most similar, in terms of token sets, entities could be then recommended to the target entity. There may be a massive amount of entities available for the search at an entity 22 such as e-service. The number may be thousands, tens of thousands, or more.

When the size of the recommendation tasks need to be scaled up, it is worthwhile to consider the dominant sources of computational complexity associated with the need for computational resources in a typical usage context and devise ways to speed up those parts of computation. As the number of users will grow, so will the number of user-specific token sets and the expected number of interaction with item sets.

However, the user sets may be private and there is potentially no direct interaction between users. Then, the bandwidth of token interactions is essentially limited by the intellectual capacity of a user, isolated from any other interaction than that implied by the web services being accessed and the amount of traffic being proportional to the minimum of web pages accessed and number of interaction incidents initiated by the user. Thus, there is neither room nor need for parallelism besides the inherent parallelism provided by the fact that individual users can be served by individual token set repositories. If the user repository is provided by a trusted operator serving a number of users, numerous such repositories can typically be served by a single-threaded repository engine without major risks on becoming an execution bottleneck.

On the contrary, the computation of recommendations for any user may become expensive, when the number of items is large for a service provider (perhaps serving numerous potential items, essentially owned by the provider), while the number of concurrent or repetitive users (customers) is also high. Then, efficient algorithms and massive parallelization would be beneficial. Unlike with user data, the item data repositories may contain numerous token sets for a myriad of items and they may be all owned by the same service organization. Then, there are no special privacy issues specific to large scale distribution or parallelization of item repositories.

### SUMMARY

The objective is to alleviate one or more problems described hereinabove not yet fully satisfactorily addressed by the known solutions managing a plurality of token sets for search and matching purposes.

The objective is achieved by embodiments of a method and arrangement in accordance with the present invention.

Accordingly, in one aspect of the present invention, a method for managing a plurality of digital token sets, wherein each digital token set comprises a plurality of tokens and is associated with a digital item, such as digital media item, available for access via an e-service, optionally Internet accessible service, wherein the digital tokens of said plurality are identifiable elements of substantially no semantic value and interaction between a user-related token set and item-related token set involves adapting both token sets based on the token set of the other party of the interaction, comprises
obtaining a first plurality of token sets associated with a corresponding plurality of digital items,
distributing said first plurality of token sets among a second plurality of at least computationally separate but communications-wise connected, functionally parallel partial repositories, such as servers or computing units, wherein said second plurality is smaller than the first plurality, the partial repositories establishing a greater joint, distributed repository from a standpoint of an external entity using or accessing the e-service, preferably an c-service user,

wherein distributing comprises utilization of a predefined evaluation logic to allocate, preferably iteratively, mutually similar, item-related, token sets, optionally according to a distance-based measure, to the same partial repository in said second plurality.

In one embodiment, the method further comprises
receiving a query for recommendations or other data indicative of a target token set associated with a target entity, preferably a user,
conducting a search among a number of partial repositories, optionally all partial repositories, to find a number of best matching token sets of digital items in accordance with a similarity criterion, optionally distance based similarity criterion, utilized for comparing the target token set to other token sets, and
returning the best matching token sets as a response.

In a related embodiment, the search incorporates parallel matching of the target token set with token sets in multiple partial repositories.

Still in a related embodiment, the search incorporates visiting or walking/traversing at least one graph, wherein the nodes are representing the token sets to be matched with the target token set. Accordingly, the token sets may be organized within each partial repository and optionally as a whole. i.e. between the partial repositories, such that a connection graph is established to enable and guide a stratified search progressing through a starting node (e.g. at any partial repository) to determine optimal or nearly optimal recommendation choice via a neighborhood-based (local) search.

In another embodiment, the evaluation logic incorporates a computational method to evaluate an optimal or close to optimal allocation of token sets based on a selected cost criterion, optionally global cost criterion.

In a related embodiment, the computational method comprises, optionally substantially continuously, determining pairwise similarity statistics on the specific set-related distance statistics on a subset of most similar distinct item token sets in the distributed item token repository.

In other related embodiment, the computational method comprises evaluating the net marginal cost of allocation of individual item token sets in any partial repository to any other of the partial repositories by weighting the resulting communication, processing and/or storage cost by the observed communication statistics.

In a further embodiment the evaluation logic incorporates a clustering method, optionally iterative clustering method, for computing optimized, e.g. an optimal, nearly optimal or at least improved, allocation of token sets among the partial repositories. The clustering method may include a substantially K-means clustering method or a variation of K-means method. There may thus be, say, K partial repositories to which e.g. N (>K) token sets shall be allocated by the clustering algorithm.

Iterative clustering or generally evaluation and reallocation of token sets among the partial repositories is cleverly utilized to cope with the fact that the token sets tend to adapt and change due to interactions between the associated host entities and/or maintenance actions, such as time-based automatic divergence, which may refer to optionally regular deletion of tokens from a set or addition of new (typically random) tokens thereto.

Therefore iteratively performing the clustering or re-clustering the token sets to the partial repositories and optionally within the partial repositories to maintain similar token sets together, may inherently take these various, not perhaps so predictable, changes in the token set construction into account. Clustering/evaluation may be iteratively, optionally substantially continuously, executed in the background during the operation of the system where the repositories are utilized in the interactions and e.g. provision of item recommendations to users.

E.g. iterative maintenance of FP (frequent pattern) trees and generally FP-growth algorithm (algorithm for association rule learning), or other applicable algorithm, may be utilized for managing the tree structure(s) facilitating the matching during a search/recommendation procedure.

Optionally, in the partial repositories a plurality of similar items may be organized according to the utilized criterion such as token set similarity such that e.g. a combined token set or a corresponding functional entity is formed, potentially enabling faster matching during a search/recommendation procedure, for instance.

In various embodiments, a partial repository comprises a computing unit for processing data and memory for storing data, the data including the token sets and instructions defining the operation logic of the computing unit. Generally the repository may be thus implemented by a server device accessible through a communications connection or network, for instance. Component-wise the computing unit of the (partial) repository may include at least one processor, whereas the memory may include at least one memory chip. The use of physically combined processing-memory devices is also possible.

In another aspect, an electronic arrangement for managing a first plurality of digital token sets, wherein each digital token set comprises a plurality of tokens and is associated with a digital item, such as digital media item, wherein the tokens of said plurality are identifiable elements of substantially no semantic value and interaction between a user-related token set and item-related token set involves adapting both token sets based on the token set of the other party of the interaction, comprising
a second plurality of at least computationally separate but communications-wise connected, functionally parallel partial repositories, optionally servers, the arrangement being configured to
obtain a first plurality of token sets associated with a corresponding plurality of digital items,
distribute the first plurality of token sets among the second plurality of partial repositories, wherein said second plurality is smaller than the first plurality, the partial repositories establishing a greater joint, distributed repository from a standpoint of an external entity using or accessing the e-service, preferably an e-service user,

wherein distributing comprises utilization of a predefined evaluation logic to allocate mutually similar item related token sets to the same partial repository in said second plurality.

Various embodiments of the method may be flexibly adapted to the arrangement mutatis mutandis, and vice versa, as being appreciated by a person skilled in the art.

The utility of different embodiments of the present invention arises from multiple issues depending on the embodiment. A large number of token sets may be effectively managed through allocating similar sets in the same repositories capable of substantially independent, speeded-up computational procedures such as token set searching and matching. Meanwhile, the (re)allocation task is solved with respect to storage, communication and computational load constraints on the cluster and associated communication network. The solution supports the construction of neighborhood relation based connection graphs with a guaranteed degree of graph connectivity to serve as the data structure to guide stratified local search progressing. The suggested infrastructure may be flexibly scaled to yield the desired performance responsive to increase in the number of managed token sets, for instance.

Further utilities of the embodiments will become evident to a skilled person based on the detailed disclosure set forth hereinafter.

The expression “a number of” refers herein to any positive integer starting from one (1), e.g. to one, two, or three.

The expression “a plurality of” refers herein to any positive integer starting from two (2), e.g. to two, three, or four.

Ordinal numerals such as “first”. “second”, or “third” are generally used herein just to distinguish physical or logical elements from each other without reference to any particular priority or order, if not otherwise explicitly stated.

The term “e-service” refers herein to any electronic service or application that may be accessed by a number of users e.g. via a communications network. The e-service may indeed be accessed using information and communication technology, such as but not necessarily the Internet and/or other network(s) or communication medium. The e-service may include or be based on a number of different aspects of (e-)commerce, online or web service in general, data storage service, data access service, data creation or modification service, computing or processing service, data transfer service, news or article service, communication service, social networking service, publication database, discussion forum, data indexing or search tool, or advertising medium among various other options.

Different embodiments of the present invention are disclosed in the dependent claims.

### BRIEF DESCRIPTION OF THE RELATED DRAWINGS

Next the invention is described in more detail with reference to the appended drawings in which

FIG. 1 illustrates a basic solution for adapting token sets associated with different entities in connection with interactions taking place between the entities.

FIG. 2 illustrates an embodiment of the present invention incorporating a plurality of partial repositories establishing a joint distributed repository for managing and maintaining token sets while responding to potential queries involving token set searching or matching activities.

FIG. 3 is a flow diagram of an embodiment of a method for token set (re)allocation within the distributed repository.

FIG. 4 is a flow diagram of a method in accordance with an embodiment of the present invention for generally managing token sets in accordance with the present invention.

### DETAILED DESCRIPTION OF THE EMBODIMENTS

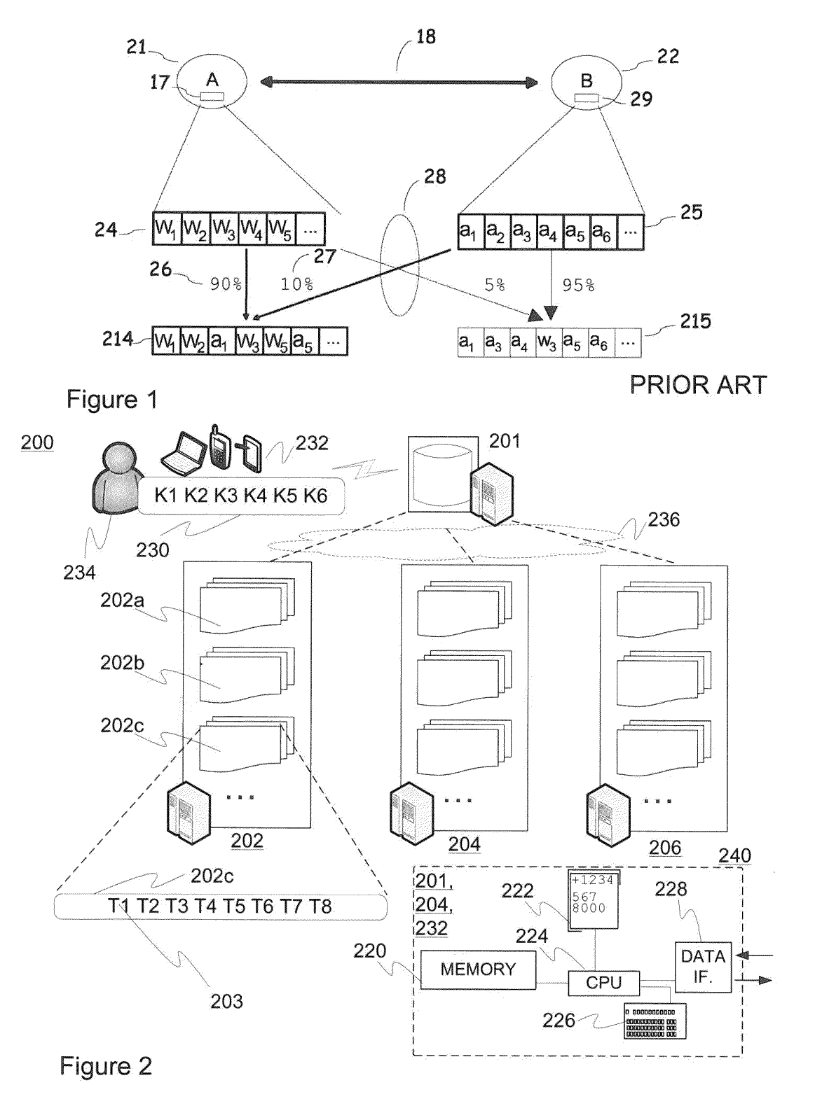

FIG. 1 was already contemplated hereinbefore in connection with the description of background and historical data relating to the origin of the present invention.

The arrangement and method in accordance with the present invention may be utilized for managing digital token sets associated with elements such as items (not users) accessible, e.g. viewable, through an c-service or other entity. Each token is preferably an identifiable element without semantic value. E.g. a certain integer may be present one realization and instance of a token. The identifier may thus be numeric, e.g. a numerical value, alphanumeric, textual, etc.

Further, the suggested solution is likely to find extensive use in matching, searching and recommendation contexts. For example, items, each associated with a dedicated token set, stored in the established distributed repository may be searched and matched with a target token set associated with a user. A number of the most similar (e.g. a suitable distance criterion, such feasible minimum distance criterion, may be applied to assess the similarity between token sets) items in terms of token set correspondence with the token set of the user may be then provided as a recommendation to the user. This application may relate to the field of e-commerce, for example, such as a web store, wherein items can represent merchandise. Alternatively, e.g. a digital item library type ensemble, optionally a scientific database, could be conveniently searched for suitable articles, etc. from the standpoint of a user by the present solution.

FIG. 2 illustrates, at 200, an embodiment of the present invention incorporating an arrangement with a plurality of partial repositories 202, 204, 206, each comprising a number of token sets 202a, 202b, 202c, or ‘stacks’, distributed among them, together establishing a greater joint, distributed repository for managing and maintaining token sets while responding to potential queries involving token set searching or matching activities. Preferably still, each token set 202a, 202b, 202c is located, as a whole, in a single repository 202, 204, 206 at a time, although certain activities such as the transfer of a set between two repositories during the re-allocation thereof may imply momentarily having two copies of the same set simultaneously at two repositories. The arrangement may be accessed by users 234 via terminal devices 232 such as mobile terminals, desktop computers, laptop computers, smartphones, tablets, communications-enabled PDA's, wearable communications-enabled devices, smart goggles, etc. A user 234 may be associated with a personal token set 230 provided to or managed by the arrangement for enabling searching and matching items to the user in the light thereof. A token set 202c, as preferably each of the sets, comprises a plurality of tokens 203 (T1, . . . , T8).

In addition to physically and/or logically distributed parts and tasks, the arrangement may comprise a number of physically and/or logically shared common elements 201. E.g. for interfacing purposes, common UI's (user interface) and/or data interface(s) could be established. Generally external interfaces (UI's, data transfer interfaces) may be provided for communication and data exchanged with various external entities, such as users, user terminals, services, servers, gateways, and networks. Also common logic in the form of computer software may be applied to execute common procedures, distribute data and processing tasks among the repositories 202, 204, 206, etc. Having regard to c-service context, e.g. a browser-based UI may be provided by a web server and a web site hosted thereat. Alternatively or additionally, e.g. native client application(s) could be used to connect to a remote service entity without browser(s). Communication connections between the repositories 202, 204, 206 may be established directly between them and/or via one or more centralized, common entities 201.

The repositories 202, 204, 206, optionally servers, may communicate via a number of communication networks 236, optionally the Internet. Also the users and other entities may access the arrangement via communication network(s) potentially including the Internet.

At least a part of the arrangement may be implemented utilizing a cloud computing system including a number of at least functionally connected computing entities such as servers. A cloud computing environment enables efficient scaling of processing and memory resources, e.g. addition or deletion of partial repositories 202, 204, 206.

In some embodiments, at least part of the arrangement may be realized by a terminal device 232 that can be then considered to belong thereto. Many terminal devices of today such as contemporary smartphones are surprisingly effective and versatile computers that are capable of executing rather complicated computational tasks e.g. in the context of token sets, token set management and adaptation.

In terms of hardware, the entities 201, 202, 204, 206, 232 may contain a plurality of elements or devices to achieve the desired functionalities in terms of data processing, storage, communication, user interfacing, etc.

The arrangement/device 201, 202, 204, 206, 232 establishing or communicating with the arrangement may comprise, see the window at 240, at least one processing element 224 such as one or more (micro)processors, micro-controllers, DSP's (digital signal processor), programmable logic chips, etc. The element 224 may be configured to execute the computer application code stored in a memory 220, which may imply processing instructions and data relative to a number of application(s) or software modules/entities associated with the present invention for managing token sets. The memory 220 may be divided between one or more physical memory chips or other memory elements. The memory 220 may further refer to and include other storage media such as a preferably detachable memory card, a floppy disc, a CD-ROM, or a fixed storage medium such as a hard drive. The memory 220 may be non-volatile, e.g. ROM, and/or volatile, e.g. RAM, by nature.

A UI may be provided and comprise a display 222, and/or a connector to an external display or a data projector, and keyboard/keypad 226 or other applicable control input means (e.g. a touch screen or voice control input, or separate keys/buttons/knobs) configured so as to provide the user of the arrangement/device with practicable data visualization and device control means. The UI may further include one or more loudspeakers and associated circuitry for sound output. Yet, as mentioned hereinbefore a remote UI functionality may be implemented by means of a web server and web site operated thereat, for example. For the purpose, data transfer interface(s) 228 may be utilized.

Indeed, the arrangement/device comprises a data transfer entity or interface 228 including e.g. a wired network interface such as LAN (Local Area Network, e.g. Ethernet) interface or a wireless network interface, e.g. WLAN (Wireless LAN) via which the arrangement/device may be connected to the Internet, for instance. Terminal devices may include a wireless cellular interface, e.g. GSM (Global System for Mobile Communications) or UMTS (Universal Mobile Telecommunications System) compliant one. Interface 228 may be applied for transferring token sets and related data such as interaction feedback data.

Reverting to the foregoing logical, thus at least partially software realizable, functionalities for instructing the underlying hardware to carry out the various procedures suggested herein may be implemented as one or more software applications executed by the processor. This computer software product may be thus provided on a non-transitory carrier medium such as a memory card, a memory stick, an optical disc (e.g. CD-ROM, DVD, Blu-ray™), or some other memory carrier.

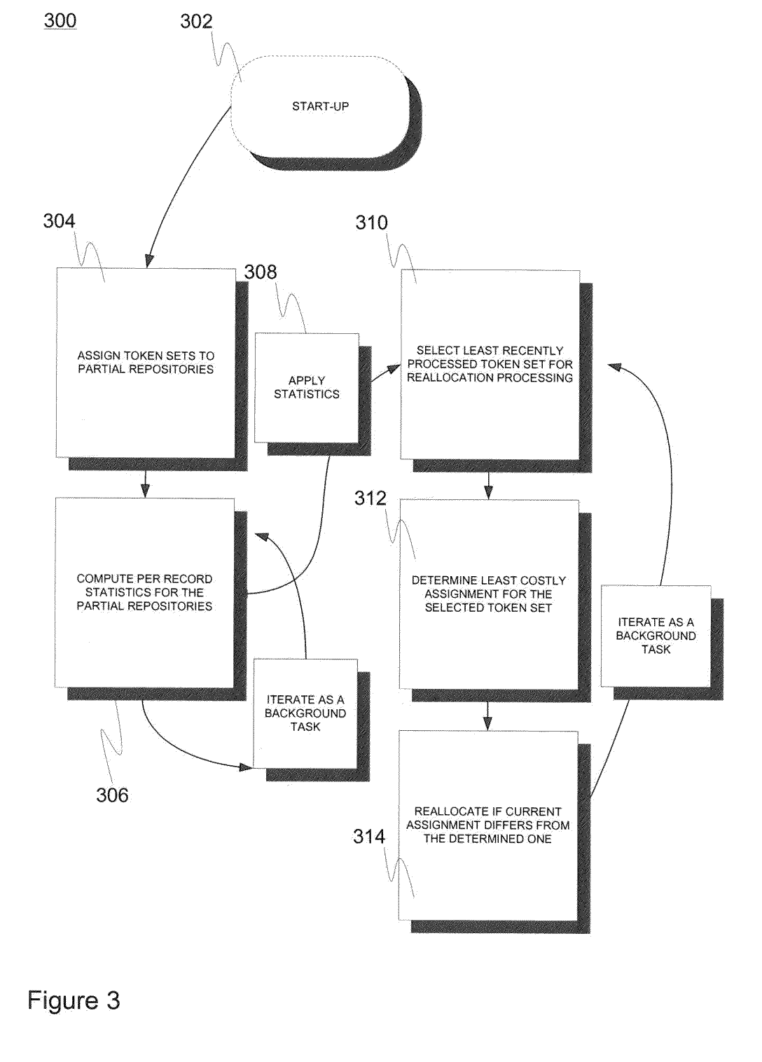

FIG. 3 shows a flow diagram, at 300, of an embodiment of a method for token set (re)allocation within the joint, distributed repository. As the method may be executed as surrounded or adjacent to other activities, the start-up phase 302 may refer to configuration of the procedure in accordance with the surrounding activity. For example, at least initial number of partial repositories may be decided based on the current number of token sets and tokens to be managed, and the repositories may be ramped up in terms of configuring the related hardware, communications connections, etc.

At 304, the token sets for different items are initially assigned to the partial repositories 1, . . . , K hosted by 1, . . . , K servers, for example.

The number of repositories may be considerably lower than the number of token sets to be distributed among them. E.g. few repositories may be applied to store hundreds, thousands or even greater number of token sets, i.e. the order of magnitude may be, but does not have to be, different.

For the task, a feasible distribution method, e.g. random shuffling, may be exploited. Alternatively, sample seeds (sample token sets picked from the overall token set population) may be first allocated to the repositories, e.g. one per repository, according to a desired criterion or method (optionally randomly), followed by matching the rest sets with the seeds to allocated them with the repository with closest seed.

At 306, predefined statistics, optionally storage and processing statistics and/or pairwise communication and processing statistics may be iteratively computed, preferably per record (i.e. token set), for all partial repositories. The statistics may be determined/updated as an iterative background task as indicated in the figure, either periodically or substantially continuously while there are sufficient processing resources available, for instance.

Through the application of computed statistics 308, a procedure shown on the right in the figure may be iteratively executed. The least recently processed token set may be first determined at 310.

Then, at 312, the least costly (re)assignment of the set may be determined by calculating predefined cost indications based on the statistics.

In case the current, existing assignment of the token set is different from the just determined optimal one, the token set shall be moved to the determined partial repository. Otherwise, it may remain in the current repository 314.

When the statistics calculation procedure 304, 306 on the left yields new updated statistics, they may be adopted 308 in the re-allocation processing 310-314.

In various embodiments, a token set may be reallocated from a partial repository to another by a procedure that may include the following actions:

i) sending the set data from an originating repository/server to a recipient,

ii) storing the said data at the said recipient,

iii) sending an acknowledgement of reception of the data by the recipient from the originating repository/server, and

iv) deleting the data acknowledged at step iii from the originating repository/server.

As one feasible embodiment or at least element of the above or other applicable token set distribution and (re)allocation procedure a clustering method is next set forth.

E.g. K-means clustering method is a beneficial approach to the task, since 1) it is iterative and can keep up and advantageously refine earlier clustering results even if the data will chance slightly, 2) the algorithm's basic logical state representation corresponds to reallocation of set data in the communication data flow sense, 3) the control for constraints like available memory and other available processing resources is analogous with well-tried strategies for cluster splitting and cluster merging, 4) the approach is not dependent on supplementary data structures that might be cumbersome or costly to maintain, while tokens are inserted and removed as an asynchronous operation as the clustering method will keep on iterating towards a nearly optimal partition with the constantly updated token stack repository contents, and 5) the reallocation operation is a simple one with known maximal duration making it possible to have partitioning solution stable throughout the iteration except for short rearrangement and synchronization instants.

There may thus be, say, K partial repositories to which e.g. N (>K) token sets shall be allocated by the clustering algorithm such as K-means clustering.

Random selection may be applied for centroids or alternatively, some predefined logic may be applied to select as “seed” token sets for the partial repositories relative to the other token sets are then compared with.

Optionally, in the partial repositories a plurality of similar items may be internally organized according to a desired criterion, preferably token set similarity, such that a combined token set is formed, potentially enabling faster matching during a search/recommendation procedure, for instance.

However, necessarily a combined, representative new token set (e.g. including tokens from the all original, constituent token sets) may not have to be physically established or stored in the concerned repository(s) or other location(s) responsive to such organizing task. Instead, a plurality of similar items, or in practice, similar token sets, may be repositioned and/or grouped together to form at least logically more uniform area or cluster of token sets within the repository. Accordingly, during a search/recommendation procedure, the concerned repository may be initially searched at a plurality of mutually distant positions for finding at least coarser matches with a target token set. At the selected position(s) where so far best match or matches were found, the search may be then more locally continued with a finer resolution. The search may thus proceed iteratively toward a similarity maximum between the target token set and item token sets stored in the repository based on first roughly finding potential locations of best-matching token sets and then continuing the search at these locations with increased spatial resolution.

The resulting re-organized token sets are advantageous for improved computational performance or faster speed of computation, when updating records for a large number of tokens, such as processing item-related tokens for cases with numerous users and a large number of items (or articles) provided by the owner of the item token sets (e.g. a web-shop operator). For example,

i) The likelihood that some of the records associated with the said reorganized token (sub)sets will not need to be operated on at all in connection with update operations is increased and such situations can be detected with minimal computation load per token subset.

ii) The likelihood that some of the records associated with the said reorganized token subsets will have a large number of token-related records in need of update is increased, but then, the likelihood that such operations can be done together for a large number of token subset records with an efficient data structure and associated algorithms like FP-Tree processing is increased, improving the relative performance for completing the update operations for the said subset of token records.

The above organizing/grouping procedure bears some high-level analogy with few other data organizing solutions, including so-called self-organizing (feature) maps (SO(F)M); in the present solution, items are organized in N-dimensional space whereas SOMs implement the mapping of the visualizations of N-dimensional input (feature) similarities to a 2-dimensional map image.

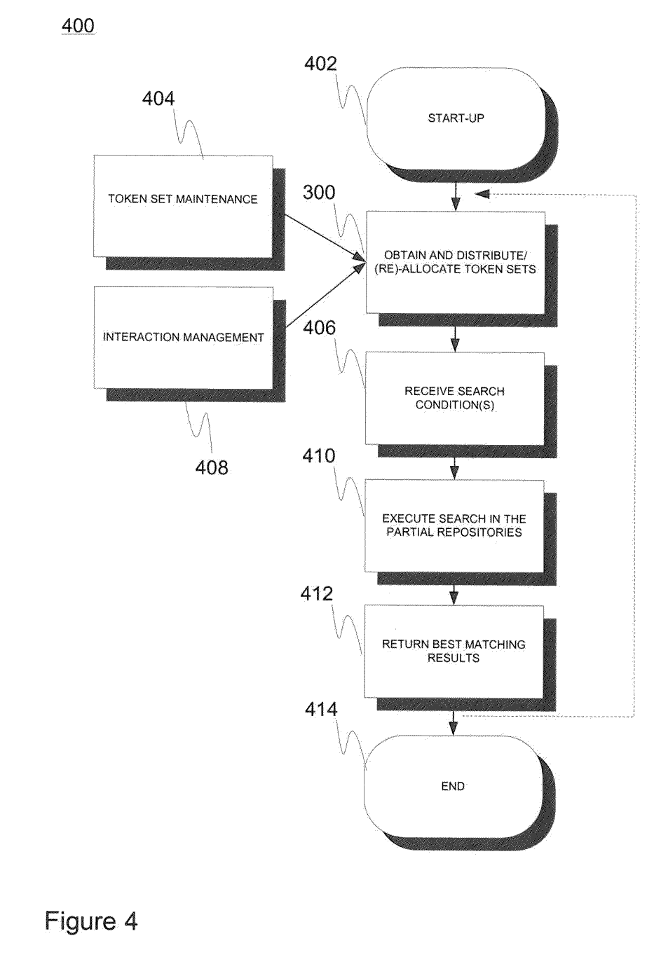

FIG. 4 shows, at 400, a flow diagram of a method in accordance with an embodiment of the present invention for generally managing token sets in accordance with the present invention.

At start-up 402, the necessary preparatory actions are taken. For example, different elements and related services may be ramped up and configured. Token exchange, adaptation, etc. logics may be adjusted to fulfill the user needs. Associated software may be provided and installed. The method may be performed by one or more electronic devices such as servers hosting the repositories among potential other duties. For example, a server arrangement of one or more servers may be adapted for the task, or the execution may be split between a number of terminal device(s) and server device(s).

Item 300 generally refers to token set distribution/(re)allocation procedures relative to the partial repositories. These may be executed as shown in FIG. 3, for instance, either as responsive to or triggered by dedicated events or substantially continuously in the background (although being shown in the diagram as an isolated method item for clarity reasons).

Item 404 refers to various token set maintenance actions and item 406 to interaction management.

Maintenance actions may include e.g. time-based (scheduled, etc.) divergence of token sets so that they in the longer run differentiate from each other more and more. Divergence may be executed by adding new tokens, e.g. random tokens, in the sets and/or deleting tokens, such as common tokens between sets, therefrom among other options. Also truncation may be executed to differentiate the sets and/or keep their size within desired limits.

Interaction management 406 may relate to the aforementioned interactions between e.g. users associated with personal token sets and items associated with dedicated token sets as well.

In response to an interaction, sets of the interacting parties may be adapted to increasingly (or decreasingly, if e.g. interaction feedback provided is negative) resemble each other. This may imply copying a token from an item-related token set to user-related token set and/or vice versa.

All alike, both maintenance 404 and interaction management 408 actions may cause changes in the associated token sets due to which also token set re-allocation 300 may be advantageous.

At 406, search conditions are received to traverse through at least part of the partial repositories. Search conditions may be input in the form of a target token set. e.g. service user related token set, for which matches should be found.

At 410, search is performed regarding the partial repositories. Matching may apply a selected distance criterion. The matching procedure may be thus based on comparing a user-specific token set with all potential item based token sets stored. When the item sets, competing to be recommended, are highly similar (typically based on highly synchronized user activity), effective joint encoding of the respective item stacks will give various schemes for effective matching algorithms such as vector-based parallel processing.

In one preferred embodiment, the condition or target token set is supplied to the partial repositories for parallel matching. E.g. a distributed search may be then executed in the repositories. A hash value and a threshold value may be associated with each search subtask so that only match results indicating closer similarity value than indicated by the threshold parameter are returned. The threshold can advantageously be used with iterative search (e.g. branch-and-bound), where partial match results from earlier phases can be used for reducing matching work for later phases by setting the threshold equal to the best similarity value found so far for any partial token repository.

At 412, a number of best matching results, i.e. token sets and/or indications of items they are associated with, are returned and utilized for constructing a related recommendation of items, for instance.

The method execution is ended at 414. The dotted loop-back arrow highlights the potentially repetitive nature of various shown method items.

Ultimately, a skilled person may, on the basis of this disclosure and general knowledge, apply the provided teachings in order to implement the scope of the present invention as defined by the appended claims in each particular use case with necessary modifications, deletions, and additions, if any.

1. A method for managing a plurality of digital token sets, wherein each digital token set comprises a plurality of tokens and is associated with a digital item available for access via an e-service, wherein the digital tokens of said plurality are identifiable elements of substantially no semantic value and interaction between a user-related token set and item-related token set involves adapting both token sets based on the token set of the other party of the interaction, comprises
obtaining a first plurality of token sets associated with a corresponding plurality of digital items,
distributing said first plurality of token sets among a second plurality of at least computationally separate but communications-wise connected, functionally parallel partial repositories, wherein said second plurality is smaller than the first plurality, the partial repositories establishing a greater joint, distributed repository,
wherein said distributing comprises utilization of a predefined evaluation logic to allocate, preferably iteratively, mutually similar, item-related, token sets to the same partial repository in said second plurality.

2. The method of claim 1, further comprising:
receiving a search query indicative of a target token set associated with a target entity, preferably a user,
conducting a search among a number of partial repositories, optionally all partial repositories, to find a number of best matching token sets of digital items in accordance with a similarity criterion, optionally distance based similarity criterion, utilized for comparing the target token set to other token sets, and
returning the best matching token sets as a response.

3. The method of claim 2, the search incorporating parallel matching of the target token set with token sets in multiple partial repositories.

4. The method of claim 2, wherein the search incorporates executing a neighborhood search including traversing at least portion of at least one connection graph, wherein the graph has been established to represent token sets as nodes to be matched with the target token set.

5. The method of claim 1, wherein the evaluation logic incorporates a predefined computational method to evaluate an optimized allocation of token sets based on a selected cost criterion, optionally global cost criterion.

6. The method of claim 5, wherein the computational method comprises determining pairwise similarity statistics on the specific set-related distance statistics on a subset of most similar distinct item token sets in the said distributed item token repository.

7. The method of claim 5, wherein the computational method comprises evaluating the net marginal cost of allocation of individual item token sets in any partial repository to any of the partial repositories by weighting the resulting communication, processing and/or storage cost by the observed communication statistics.

8. The method of claim 1, wherein the evaluation logic incorporates a clustering method, optionally iterative clustering method, for computing optimized allocation of token sets among the partial repositories.

9. The method of claim 8, wherein the clustering method comprises essentially K-means clustering.

10. The method of claim 1, wherein multiple token sets are merged to create a combined token set in a partial repository for accelerating a subsequent search procedure.

11. An electronic arrangement for managing a first plurality of digital token sets, wherein each digital token set comprises a plurality of tokens and is associated with a digital item, such as digital media item, wherein the tokens of said plurality are identifiable elements of substantially no semantic value and interaction between a user-related token set and item-related token set involves adapting both token sets based on the token set of the other party of the interaction, comprising
a second plurality of at least computationally separate but communications-wise connected, functionally parallel partial repositories, the arrangement being configured to
obtain a first plurality of token sets associated with a corresponding plurality of digital items,
distribute said first plurality of token sets among the second plurality of partial repositories, wherein said second plurality is smaller than the first plurality, the partial repositories establishing a greater joint, distributed repository,
wherein distributing comprises utilization of a predefined evaluation logic to allocate mutually similar item related token sets to the same partial repository in said second plurality.

12. The arrangement of claim 11, configured to execute allocation iteratively so as to implement reallocation of token sets between the partial repositories upon fulfillment of a number of predefined reallocation criteria.

13. A computer program comprising a code means adapted, when run on a computer, to execute the method of claim 1.

14. A carrier medium comprising the program of claim 13.
